(19) United States
(12) Patent Application Publication
(10) Pub. No.: US 2002/0188643 A1
(43) Pub. Date: Dec. 12, 2002

(54) Method and system for a model-based approach to network management

(75) Inventor: Thomas A. Kennedy, Leander, TX (US)

Correspondence Address: Joseph R. Burwell, Law office of Joseph R. Burwell, P.O. Box 28022, Austin, TX, 78755-8022, US

(73) Assignee: INTERNATIONAL BUSINESS MACHINES CORPORATION, ARMONK, NY

(21) Appl. No.: 09/876,066

(22) Filed: Jun. 7, 2001

(51) Int. Cl. G06F 17/00

(52) U.S. Cl. 709/1

(57) ABSTRACT

A method, a system, an apparatus, and a computer program product are presented for monitoring or managing a network using an object-oriented enterprise model. A set of objects are generated for the object-oriented enterprise model. An object is defined using an object-oriented language, and an object represents a device, a system, a collection of devices and/or systems, an executable program component, or a collection of executable program components within the network. An enterprise model is also defined using the object-oriented language such that the enterprise model is a set of related objects. Policies are created using the object-oriented language in which a policy contains one or more conditions and associated actions within the network. The policies can then be executed to perform monitoring and/or management tasks within the network.

### BACKGROUND OF THE INVENTION

1. Field of the Invention

The present invention relates to an improved data processing system and, in particular, to a method and apparatus for computer network management.

2. Description of Related Art

A typical network management solution requires the use of multiple network management applications in tandem. Each of the network applications performs a set of tasks for monitoring and managing the hardware and software distributed throughout an enterprise. For example, a typical network management solution might include the following list of network management applications: a software distribution application may be used to install and configure software applications; a network inventory application may be used to generate a list of existing hardware and software items; a distributed monitoring application may be used to monitor and manage resources on a local level throughout a network; and a network console application may be used to view network-related information by network operators or system administrators. In some networks, multiple applications may perform similar operations but on different portions of a network, e.g., a first application that monitors certain nodes throughout a global enterprise and a second application that performs similar monitoring operations on a particular subnet of the global network.

Frequently, customized tools are required to integrate and maximize the usefulness of the aforementioned applications. Even though the applications may be integrated in some manner, there are numerous shortcomings, which are listed here and explained in more detail below. Some of the applications do not integrate seamlessly, e.g., the applications may use different syntax or data formats for the specification and configuration of the monitoring and management policies. There may be considerable overlap in functionality between many of the applications, which leads to unnecessary operational complexity and particular difficulty in implementing system changes. Installation and configuration of the applications are usually not simple tasks, and designing and integrating a new application is usually not trivial.

Since most applications utilize differing formats for configuration, it is not surprising that the applications would not integrate well. For example, when deploying an application in a new environment, it may be necessary to create new event classes with associated processing rules, thereby requiring sophisticated knowledge of the enterprise into which the application is being deployed. Since it is quite possible that two applications may use different data formats for network events, event messages between the two applications may need to be translated, which may require customized middleware.

Each application may use different syntax for specifying configuration, monitoring, and management policies. Thus, the user must learn an operational paradigm for each application. For example, the distributed monitoring application may use its own language for its policies while the network console application uses a set of rules in conjunction with the Prolog language in order to perform its tasks.

Since most applications are developed independently, it is not surprising that considerable overlap in functionality is present in the various applications. For instance, a distributed monitoring application can detect a condition and respond by performing an action or by sending an event to the network console application. Likewise, the network console application can also detect the condition and response appropriately, yet the manner in which the applications gather data from the system may vary. One application may be specialized to perform certain monitoring operations, while another application can receive rules that direct it to perform similar monitoring operations. In some cases, one application may perform the same functionality as several other applications combined, although on a much smaller scale using different technology.

Installation and configuration of a new application can be a complex process. Even though similar steps may be required by a network administrator for each application that is installed, each application is usually installed individually, thereby requiring that the network administrator learn different requirements for each application.

Integrating a new application into an existing suite of applications may require the creation of customized middleware or, if the application suite has anticipated the inclusion of additional applications, at least the customization of some type of integration module that informs the application suite of some of the operational parameters of the new application. Since all applications work somewhat differently, integration can be a sizable task, and there is often a need for customized tools to assist a network administrator in performing some of the integration tasks.

These inadequacies in prior solutions require an alternative approach to enterprise management. Therefore, it would be advantageous to have a methodology for presenting to the user a seamless view of the domain to be monitored and managed in which the notion of separate applications is replaced by a uniform set of network-related policies that accomplish the desired monitoring and management functionality. It would be particularly advantageous if the methodology lends itself to structured analysis, development, and deployment of the various network management applications.

### SUMMARY OF THE INVENTION

A method, a system, an apparatus, and a computer program product are presented for monitoring or managing a network using an object-oriented enterprise model. A set of objects are generated for the object-oriented enterprise model. An object is defined using an object-oriented language, and an object represents a device, a system, a collection of devices and/or systems, an executable program component, or a collection of executable program components within the network. An enterprise model is also defined using the object-oriented language such that the enterprise model is a set of related objects. Policies are created using the object-oriented language in which a policy contains one or more conditions and associated actions within the network. The policies can then be executed to perform monitoring and/or management tasks within the network. A condition may be defined with an operator having an object as an operand in which the operator is defined within the object-oriented language. An action may be defined with an operation on an object within the enterprise model in which the operation is defined within an object-oriented class for the object.

### BRIEF DESCRIPTION OF THE DRAWINGS

The novel features believed characteristic of the invention are set forth in the appended claims. The invention itself, further objectives, and advantages thereof, will be best understood by reference to the following detailed description when read in conjunction with the accompanying drawings, wherein:

FIG. 1A depicts a typical distributed data processing system in which the present invention may be implemented;

FIG. 1B depicts a typical computer architecture that may be used within a data processing system in which the present invention may be implemented;

FIG. 2 is a flowchart depicting a process for developing a model-based approach to enterprise management in accordance with the present invention;

FIG. 3 is a block diagram with a graphical overview for developing and using an enterprise management model in accordance with the present invention;

FIG. 4 is a block diagram depicting an example of an enterprise model that may be used for an IT environment;

FIGS. 5A-5H are a set of diagrams that show examples of Enterprise Management Language (EML) statements for defining an enterprise model and its policies in accordance with a preferred embodiment of the present invention;

FIG. 6 is an EML example that illustrates a portion of a security policy in accordance with the present invention;

FIG. 7 is an EML example that illustrates a portion of a simple network management solution in accordance with the present invention; and

FIGS. 8A-8C is a set of diagrams shows examples of EML statements for integrating pre-existing applications with an enterprise model in accordance with the present invention.

### DETAILED DESCRIPTION OF THE INVENTION

The present invention is directed to a system and a methodology for network management. As background, a typical organization of hardware and software components within a distributed data processing system is described prior to describing the present invention in more detail.

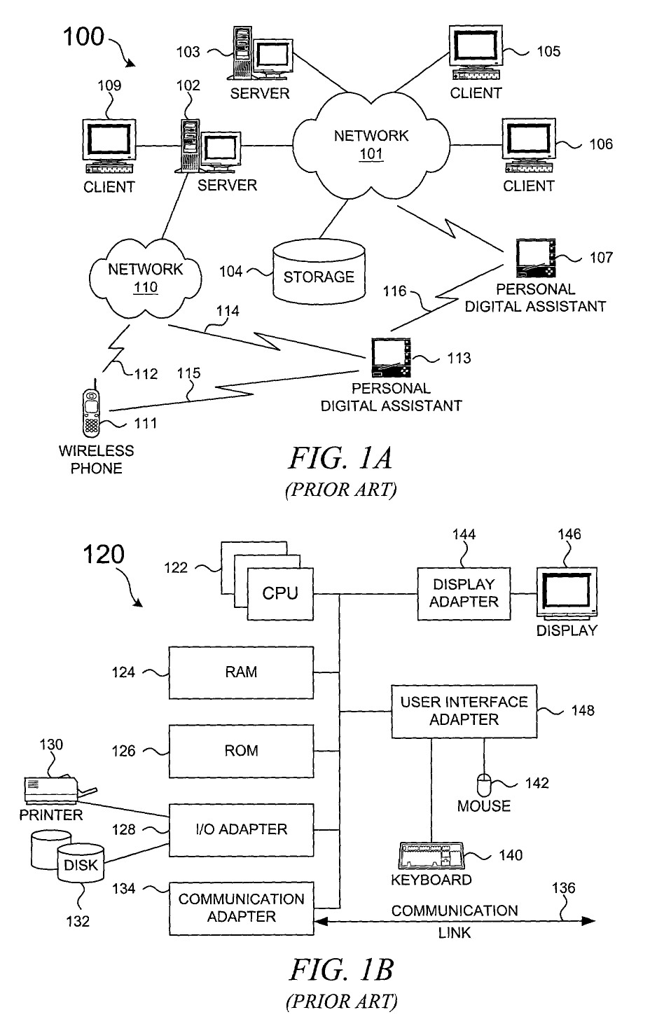

With reference now to the figures, FIG. 1A depicts a typical network of data processing systems, each of which may contain and/or operate the present invention. Distributed data processing system 100 contains network 101, which is a medium that may be used to provide communications links between various devices and computers connected together within distributed data processing system 100. Network 101 may include permanent connections, such as wire or fiber optic cables, or temporary connections made through telephone or wireless communications. In the depicted example, server 102 and server 103 are connected to network 101 along with storage unit 104. In addition, clients 105-107 also are connected to network 101. Clients 105-107 and servers 102-103 may be represented by a variety of computing devices, such as mainframes, gateways, personal computers, personal digital assistants (PDAs), etc. Distributed data processing system 100 may include additional servers, clients, routers, other devices, and peer-to-peer architectures that are not shown.

In the depicted example, distributed data processing system 100 may include the Internet with network 101 representing a worldwide collection of networks and gateways that use various protocols to communicate with one another, such as Lightweight Directory Access Protocol (LDAP), Transport Control Protocol/Internet Protocol (TCP/IP), Hypertext Transport Protocol (HTTP), Wireless Application Protocol (WAP), etc. Of course, distributed data processing system 100 may also include a number of different types of networks, such as, for example, an intranet, a local area network (LAN), or a wide area network (WAN). For example, server 102 directly supports client 109 and network 110, which incorporates wireless communication links. Network-enabled phone 111 connects to network 110 through wireless link 112, and PDA 113 connects to network 110 through wireless link 114. Phone 111 and PDA 113 can also directly transfer data between themselves across wireless link 115 using an appropriate technology, such as Bluetooth™ wireless technology, to create so-called personal area networks (PAN) or personal ad-hoc networks. In a similar manner, PDA 113 can transfer data to PDA 107 via wireless communication link 116.

The present invention could be implemented on a variety of hardware platforms; FIG. 1A is intended as an example of a heterogeneous computing environment and not as an architectural limitation for the present invention.

With reference now to FIG. 1B, a diagram depicts a typical computer architecture of a data processing system, such as those shown in FIG. 1A, in which the present invention may be implemented. Data processing system 120 contains one or more central processing units (CPUs) 122 connected to internal system bus 123, which interconnects random access memory (RAM) 124, read-only memory 126, and input/output adapter 128, which supports various I/O devices, such as printer 130, disk units 132, or other devices not shown, such as a audio output system, etc. System bus 123 also connects communication adapter 134 that provides access to communication link 136. User interface adapter 148 connects various user devices, such as keyboard 140 and mouse 142, or other devices not shown, such as a touch screen, stylus, microphone, etc. Display adapter 144 connects system bus 123 to display device 146.

Those of ordinary skill in the art will appreciate that the hardware in FIG. 1B may vary depending on the system implementation. For example, the system may have one or more processors, including a digital signal processor (DSP) and other types of special purpose processors, and one or more types of volatile and non-volatile memory. Other peripheral devices may be used in addition to or in place of the hardware depicted in FIG. 1B. The depicted examples are not meant to imply architectural limitations with respect to the present invention.

In addition to being able to be implemented on a variety of hardware platforms, the present invention may be implemented in a variety of software environments. A typical operating system may be used to control program execution within each data processing system. For example, one device may run a Unix® operating system, while another device contains a simple Java® runtime environment. A representative computer platform may include a browser, which is a well known software application for accessing hypertext documents in a variety of formats, such as graphic files, word processing files, Extensible Markup Language (XML), Hypertext Markup Language (HTML), Handheld Device Markup Language (HDML), Wireless Markup Language (WML), and various other formats and types of files.

The present invention may be implemented on a variety of hardware and software platforms, as described above. More specifically, though, the present invention is directed to a system and a methodology for a model-based approach to network management, as described in more detail below with respect to the remaining figures.

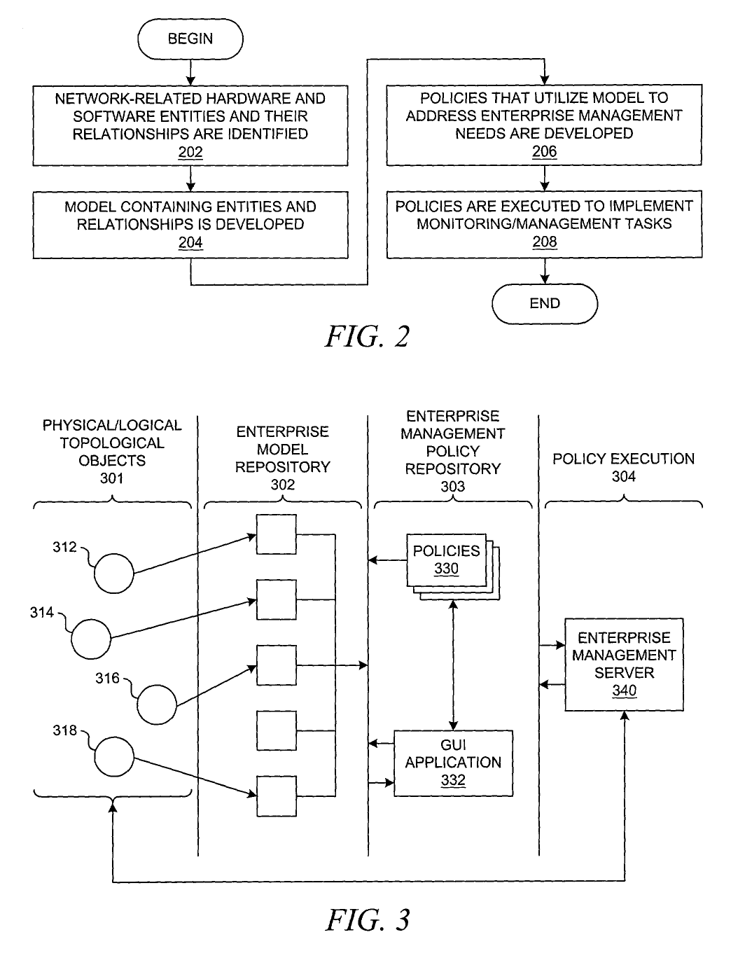

With reference now to FIG. 2, a flowchart depicts a process for developing a model-based approach to enterprise management in accordance with the present invention. The process begins by identifying network-related hardware, software, and other physical or logical entities and their relationships (step 202). A unifying model containing these entities and their relationships is developed (step 204), and policies that utilize the model to address enterprise management needs are written (step 206). These policies are then executed on devices throughout the enterprise to implement the policies (step 208), and the process is complete. The development of the model and its use is described in more detail below with respect to FIG. 3.

With reference now to FIG. 3, a block diagram provides a graphical depiction of the process for developing and using an enterprise management model in accordance with the present invention. The explanation of FIG. 3 follows the steps outlined in FIG. 2; FIG. 3 shows physical/logical topology 301, enterprise model 302, enterprise management policies 303, and enterprise management policy execution 304.

The first step towards model-based enterprise management is to identify all items of interest and their relationships. Physical/logical topology 301, i.e., the domain of interest contains physical and logical items 312-318 that an enterprise administrator wishes to monitor and/or manage. Physical entities may includes items that physically exist, whereas logical entities are intangible items. For an information technology (IT) domain, physical entities are usually hardware but may include users, such as database administrators, network administrators, network technicians, hardware support personnel, etc. Physical entities may also include copies of executable program components. Examples of hardware may include various types of data processing systems, such as those shown in FIG. 1A, but may include hardware subsystems, such as hard drives, etc. Logical entities may include functions or any abstract concept that may be represented by an object or class. For example, a network is an example of a logical item because it is a collection of connected hardware items and not a distinct physical item itself. Similarly, a disk partition is a logical item; multiple disk partitions may be presented to a user as multiple disk drives, yet there may be only a single physical drive supporting the multiple partitions. This step of identifying items of interest can be assisted to an extent by using a network inventory application.

The second step towards model-based enterprise management is to define a model based on the identified items of interest and their relationships. Each item and each relationship between items that were identified in physical/logical topology 301 should have a corresponding definition in enterprise model 302. In other words, a model is a collection of objects and their relationships, and each item is represented by an object. Examples of relationships may include inheritance, containment, or direct association. When the construction of an enterprise model is complete, the enterprise model should be familiar to the users of the systems within the enterprise, such as system administrators, because the model should reflect those user's domain knowledge.

The resulting model is then stored in a model repository to allow reuse throughout the enterprise, although the model repository may be a distributed database. By containing the model within a single repository, an inherent mechanism is provided for detecting conflicts that might be introduced into the model during simultaneous editing by multiple users because a database that would be used to implement the repository would lock portions of the database such that only one user could update a given portion at any given time.

The third step towards model-based enterprise management is to develop appropriate enterprise management policies 303 for managing the enterprise while utilizing enterprise model 302. Policies can be used to perform tasks or to specify monitoring/management parameters, and the collection of all policies 330 constitutes the overall enterprise management strategy. GUI application 332 may be used by a system administrator to generate and manage policies 330. The policies can address related or independent problems or tasks, and any number of policies can be specified, whether reactive or proactive in nature. The scope to which a policy applies can be specified arbitrarily.

For example, a monitoring/management policy, such as a policy to detect and react to a node failure, will specify the items to monitor, the manner in which the items are monitored, and the actions to take as a result of detecting a condition of interest. A policy that performs a useful task, such as a daily system backup, will specify the start and stop criteria along with the explicit actions to be performed for the task.

In a manner similar to storing the enterprise model, the resulting policies are stored in a policy repository to allow reuse throughout the enterprise, although the policy repository may be a distributed database. By containing the model within a single repository, an inherent mechanism is provided for validating policies against their associated enterprise model.

The fourth and final step towards model-based enterprise management is policy execution 304. Policies may be executed on Enterprise Management Server (EMS) 340, which also provides an application programming interface (API) for inspecting and modifying the policies during runtime so that policies can be viewed and modified without stopping and restarting the server. Each policy can be assigned a priority for priority-scheduled execution, and policies can be executed in parallel; the policies may also be dispatched to run on selected nodes throughout the enterprise.

Policies may be written in the Enterprise Management Language (EML); once a policy is initiated, its EML code is interpreted, and the services needed by the policy are deployed and started and then monitored as necessary. EML is used to define a model and associated monitoring/management policies, as explained in more detail further below. It should be noted that the EML statements in the following description conform to an exemplary language and syntax; similar interpretable languages with corresponding functionality but different syntax could be used to implement the present invention within a given system.

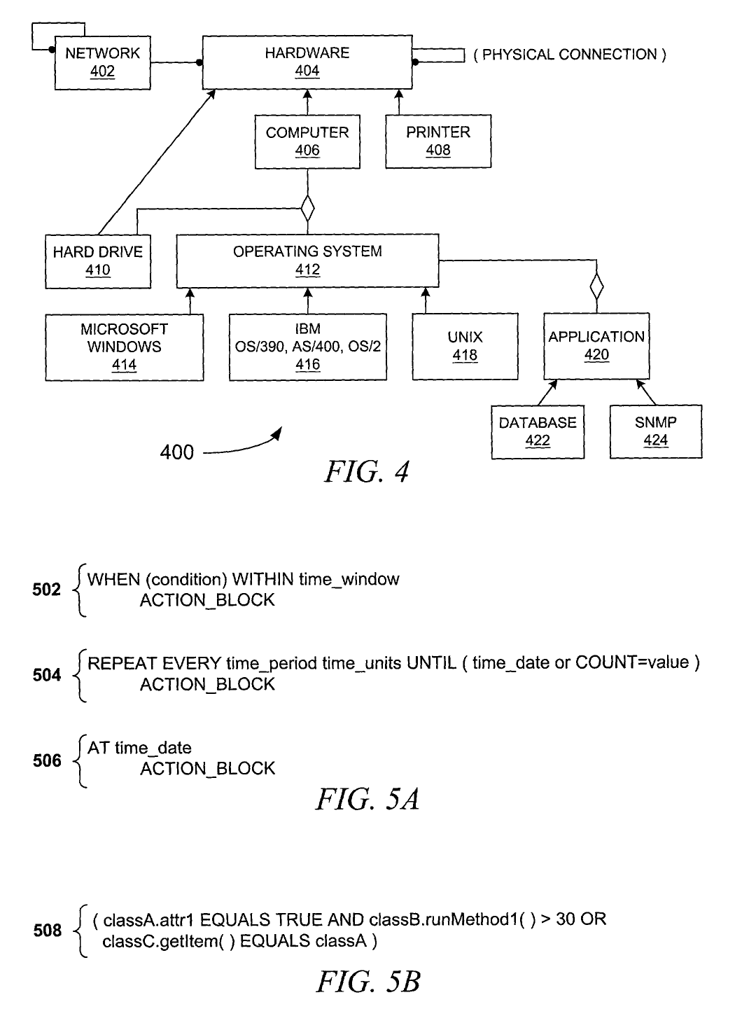

With reference to FIG. 4, a block diagram depicts an example of an enterprise model that may be used for an IT environment. While enterprise models may be most frequently used for IT environments, an enterprise model can be developed for many different environments, such as monitoring and managing an assembly line.

Enterprise model 400 represents an organization of items that may be found in a typical enterprise. Network 402 is a collection of hardware items 404 and other items; network 402 may be interconnected to other networks, although the hardware items may be physically coupled to other items. Network 402 may comprise computers 406, printers 408, and hard drives 410. Each computer has an operating system 412, which may be selected from the Microsoft Windows family 414, IBM family 416, or Unix family 418 of operating systems. An operating system may run applications 420, such as database application 422 or SNMP (Simple Network Management Protocol) application 424.

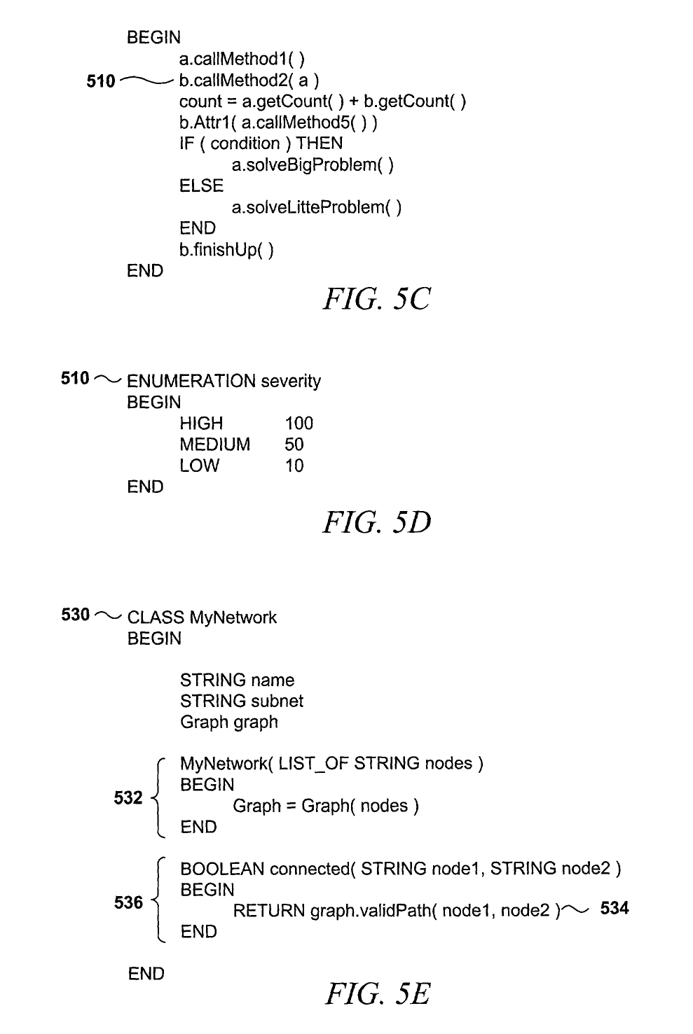

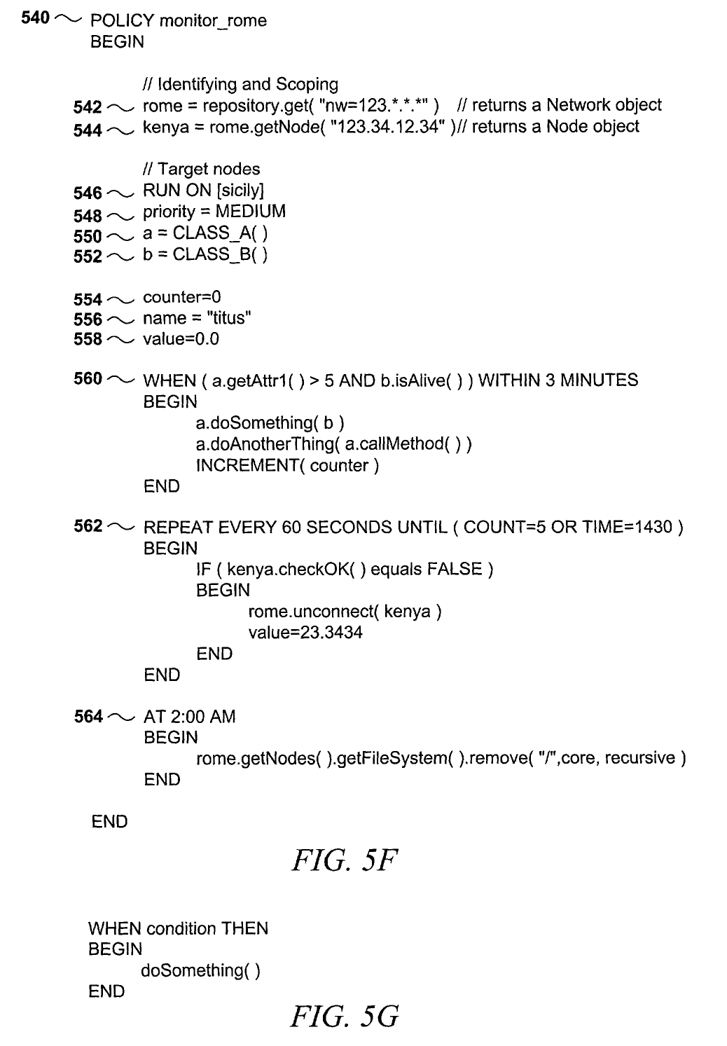

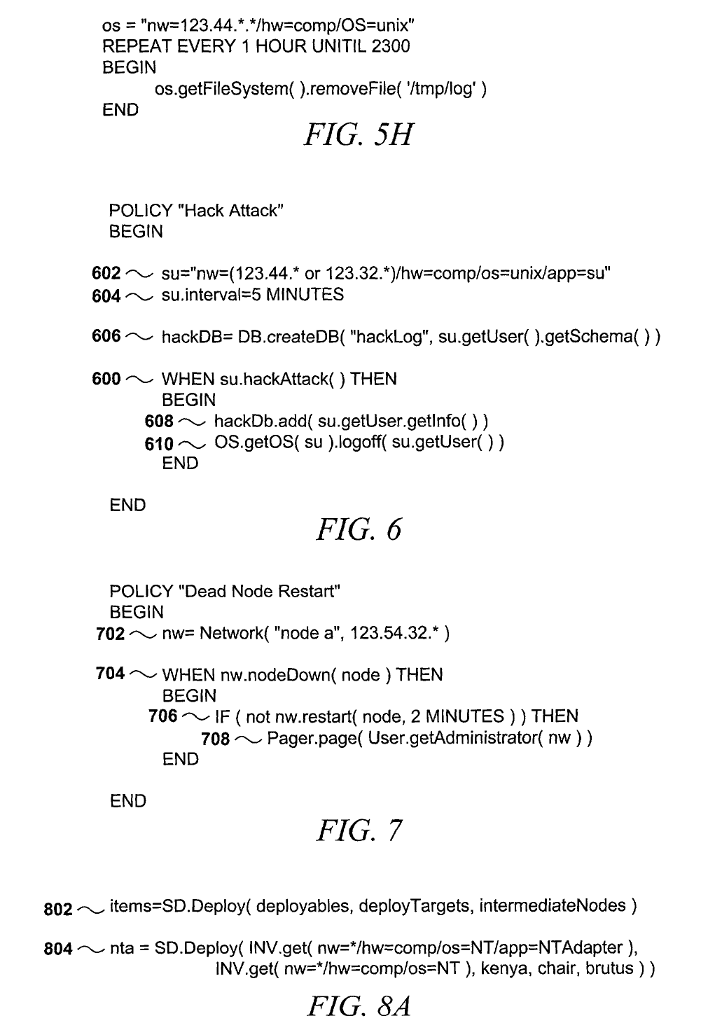

With reference now to FIGS. 5A-5H, a set of diagrams shows examples of Enterprise Management Language (EML) statements for defining an enterprise model and its policies in accordance with a preferred embodiment of the present invention. As noted above, EML is used to define the model and associated monitoring/management policies. The language consists of a set of reserved words, objects, and operators. Reserved words form the underlying structure of models and policies. Objects serve as operands of the operators; together, objects and operators define conditions and actions in a policy.

Reserved words are selected such that they allow the user to specify, in a declarative manner, the desired tasks to be performed. The syntax for the reserved words is structured such that the reserved words map to the concepts that a user would think about while solving a problem, thereby simplifying the modeling process when mapping a problem to an implementation. The set of reserved words may vary depending on the requirements of an implemented system. Some examples of reserved words are explained below; the provided examples should not be construed as being exhaustive.

As explained in more detail further below, a model is a collection of related objects; assuming that the model is constructed in an object-oriented manner, the objects may comprise executable program components, i.e., the executable program components have the form of classes, and EML uses CLASS as a reserved word for defining classes to be consistent with other well-known object terminology. POLICY is the reserved word used to define policies; conditions and action blocks form a complete policy.

Referring to FIG. 5A, the monitoring of a condition is accomplished with the WHEN reserved word. Statements 502 show that when a condition is true within a given time window, a block of actions is executed. Repetitive tasks are specified using the REPEAT reserved word. Statements 504 show that every time period, e.g., SECOND, MINUTE, HOUR, etc., a block of actions is performed; this continues until some time/date occurs or the task has repeated a pre-specified number of times. A block of actions can also be scheduled in the future using the AT reserved word. Statements 506 shows that a block of actions are to be executed at a specified time or date. Reserved words for typical execution flow control are also supported, such as IF-THEN-ELSE, WHILE and FOREACH, which can be used within action blocks.

Referring to FIG. 5B, conditions are used to specify criteria to monitor or divert flow within an action block. A condition is a set of interleaved operators and operands. Operators are similar to the typical set of operators supported by most general purpose languages, e.g., IS, EQUALS, >, <, AND, OR, NOT, etc.; operands can only be objects. An object itself can be used as an operator in a condition; furthermore, an attribute of an object, which is an object, can be used as an operand. Similarly, the return value from a call to an object's method, which is an object, can also be an operand. FIG. 5B shows an example of a condition using all three types of operands. In statement 508, the first operand is an attribute, attribute “attr1” of class “classA”; the second operand is a boolean object (“TRUE”); the third operand is the return value from a call to method “runMethod1( )” of class “classB”; the fourth operand is an integer object (“30”); the fifth operand is the return value from a call to method “getitemo” of class “classC”; and the sixth operand is an object, class “classA. The operators are the EQUALS operator, the boolean operators AND and OR, and the mathematical greater-than (“>”) operator.

An action block is a sequence of statements that perform a specific task; the statements are framed with the reserved words BEGIN and END. In addition, action blocks may have embedded control flow reserved words. FIG. 5C shows an example of an action block; using a sequence of statements with appropriate control flow, different size problems can be resolved. Statement 510 shows that data can be passed between objects as arguments to method calls.

Inspection of the examples in FIGS. 5A-5C shows that a condition and action block can be realized as expressions. A condition is an expression containing interleaved objects and operators with a boolean result; an action block is a sequence of expressions, wherein each expression is also a set of interleaved operators and operands. In both cases, all operands are objects. As explained above with respect to FIG. 3, objects can represent any item in a domain of interest. Since an object can be constructed to provide all necessary services needed to interact with the domain, a condition can be used to detect any desired criteria within the domain, and an action block can be used to react in any desired manner. Thus, the use of conditions and actions in conjunction with objects as the operands in the expressions within one or more policies provides an adaptable foundation for monitoring and managing systems. Hence, the ability to monitor/manage a given environment can be reduced to using this object-based approach in conjunction with an appropriately defined set of domain objects. The manner in which objects are defined is explained in more detail below.

A model is a collection of related classes. The relationships between classes are specified via the well-known relations of inheritance, aggregation, or direct association. There are three types of classes: utility, application, and user-defined classes. Utility classes encapsulate general purpose functionality that may be used across all policies, e.g., an “OperatingSystem” class. Utility classes may be defined through EML statements to specifically integrate objects for a particular enterprise. However, one or more generic models could be provided such that many default classes would be available within the generic models. For example, most large enterprises have an IT infrastructure that includes multiple types of operating systems; hence, an “OperatingSystem” class would be useful for the models that are designed for these enterprises, and the “OperatingSystem” class could be provided as part of a basic installment of the present invention.

Application classes encapsulate the functionality of deployed or installed applications. For example, a “NetConsole” class may represent functionality for a network console application, and a “Monitor” class may represent functionality for a distributed monitoring application. In other words, application classes are created by decomposing an application into a set of objects that represent useful functionality. As part of the modeling process, the decomposition should identify duplicate functionality within the applications and then retain the best implementation for a given functionality as an object.

User-defined classes are classes with useful functionality for inclusion within a model which are not otherwise defined within a set of utility or application classes. User-defined classes can be defined within EML using the CLASS keyword. An EML CLASS may contain methods and attributes. Attributes can be of various types, such as ENUMERATION, BOOLEAN, INTEGER, STRING, DOUBLE, or CLASS. An attribute can also be a collection of these types. Relationships between classes are specified via inheritance or attribute definitions.

Referring to FIG. 5D, the ENUMERATION keyword is used to define an EML enumerated type, which defines a name-index relationship. Statement 520 shows the use of an ENUMERATION keyword in conjunction with a BEGIN-END block to define a set of name-value pairs.

Referring to FIG. 5E, an example of an EML class that models a network is shown. Statement 530 declares a “MyNetwork” class that has “name” and “subnet” attributes that are used to uniquely identify the class object. The constructor for the “MyNetwork” class, shown at statements 532, initializes the graph. The class leverages a “graph” package to perform certain low-level tasks for network analysis, as shown at statement 534. The “connected” method defined within the “MyNetwork” class, shown at statements 536, provides functionality that would be useful to the designer or creator of a network model.

In a fashion similar to that shown in FIG. 5E, classes can be developed to model any entity in the domain of interest, i.e., to represent any object within the enterprise model. After the classes and the associated model have been developed, policies to be used with the model can be developed, as explained in more detail below.

A policy allows the user to specify all aspects of a given monitoring task and/or management task. For example, a policy can be used to accomplish the following tasks: identifying the type of items to monitor and manage; specifying the associated scope of these items, e.g., for deploying the items; setting appropriate parameters for the items, e.g., for configuring the items; defining the monitoring criteria; defining the monitoring and/or management function or task; specifying the target nodes on which to run the policy.

Referring to FIG. 5F, an example of a policy is shown. As shown in statement 540, the policy is named “monitor_rome” as is specified after the POLICY reserved word. Statements 542 and 544 show that this policy is concerned with a network named “rome” and a node in this network named “kenya”; “rome” is a “Network” object that is retrieved from the model repository, and “kenya” is a “Node” object. In this manner, the types of items of interest and their associated scope can be specified.

Statement 546 states that the policy is executed on node “sicily”, and statement 548 states that the policy should be executed at medium priority. As shown in statements 550 and 552, The policy utilizes two local variables, named “a” and “b” which are of type CLASS_A and CLASS_B, respectively. As shown in statements 554, 556, and 558, other local variables of type integer, string, and float are also defined for use within the policy as needed.

The remaining statements within the policy definition define the monitoring and management criteria for this policy. As shown at statement 560, a WHEN statement identifies a condition to monitor with an associated action block that is to be performed when the condition is detected. As shown at statement 562, a REPEAT statement declares a task to perform periodically. As shown at statement 564, an AT statement specifies a task that is to be performed at a specific time.

Arbitrary scoping is supported to allow flexibility when targeting where a policy applies. In these examples, the scoping feature uses so-called Distinguished Name (DN) notation, which is well-known and is used by Lightweight Directory Access Protocol (LDAP) servers. These servers support saving and retrieving information using the DN notation and may be used for implementing scoping in the EMS shown in FIG. 3. The distinguished name syntax is used to specify the scope for a policy, as is shown at statement 542 in FIG. 5F. For instance, the following refers to all Unix machines in the aforementioned model:

nw=*/hw=comp/os=Unix.

Similarly, the following refers to Unix machines only on certain subnetworks:

nw=(123.34.23.* or 345.563.12.*/hw=comp/os=Unix”.

Finally, the following refers to all DB2 applications in the enterprise:

nw=*/comp=*/os=*/app=DB2.

If the user understands the model that is being used for an enterprise, then specifying a scope is straightforward; it consists of navigating the model in a hierarchical fashion to the items of interest in the domain. Appropriate filters, e.g., AND, OR, etc., are placed as necessary in order to achieve the desired scope for the policy.

Referring to FIGS. 5G-5H, policies may be considered either reactive or proactive. Reactive policies are primarily used to detect problems within the domain; a reactive policy comprises a condition and an associated action in which the condition is dependent on the state of an object. As shown in FIG. 5G, a reactive policy detects a condition and reacts to the condition. A policy may be considered a proactive policy if it is concerned only with temporal conditions. In other words, proactive policies are performed at a specific time or repeated periodically without regard to the state of any object; they consist of a frequency specification, an optional termination criteria, and an associated action. As shown in FIG. 5H, a proactive policy removes the “/tmp/log” file every hour before 2300 hours.

With reference now to FIG. 6, an EML example illustrates a portion of a security policy in accordance with the present invention. The example in FIG. 6 assumes that an “su” class has been defined to monitor the output of the “su” processes. As shown at statement 600, the “su” class contains a method called “hackAttack” which is able to detect when a user attempts to logon as root using the “su” program. A hack attack is defined as three failures to “su” to root on the same machine within 3 minutes by the same user. The “Hack Attack” policy shown in FIG. 6 allows the security administrator to be informed when these criteria are met.

Statement 602 identifies the item of interest as the “su” application on Unix machines in two distinct networks. In this case, the administrator has previously decided that the interval is too strict, so statement 604 changes the interval to a five minute window. At statement 606, a database table to log all hack attacks is created using the “DB” class in which the results are stored in a table call “hackLog”. This table is to have a schema suitable for the “su” program. The monitoring policy is defined within the action block associated with the WHEN condition at statement 600. When a hack attack is detected, the data related to the “su” instance reporting the attack is sent to the hack log table at statement 608. This data might include the user name and the user's origin IP address. At statement 610, the user is logged off with the “OS” class.

The example shown in FIG. 6 includes all installation, configuration, and monitoring/managing knowledge required to implement the policy. Installation is addressed by requiring “su” monitors on all Unix machines. Configuration is addressed by allowing the interval attribute to be set, which would be set before the “su” monitors are deployed. Monitoring and management are addressed via the WHEN statement.

With reference now to FIG. 7, an EML example illustrates a portion of a simple network management solution in accordance with the present invention. The example in FIG. 7 detects when a node is down and attempts to restart it. If the node cannot be restarted, then the appropriate administrator is paged.

Statement 702 creates a “Network” object instance on “node a” that monitors all nodes in network “123.54.32.*”. Statement 704 specifies the desired monitoring, i.e., if a node goes down on the network, then an attempt is made to restart it at statement 706. If the node does not restart within 2 minutes, then statement 708 pages the administrator for the network.

The present invention has an advantage because it may be integrated with existing technology such that an enterprise may leverage its current investments in technology. In addition, the present invention can also be integrated with new technology. In either case, system functionality in previously deployed technology or new technology can be encapsulated within classes with appropriate interfaces in a manner similar to those described below.

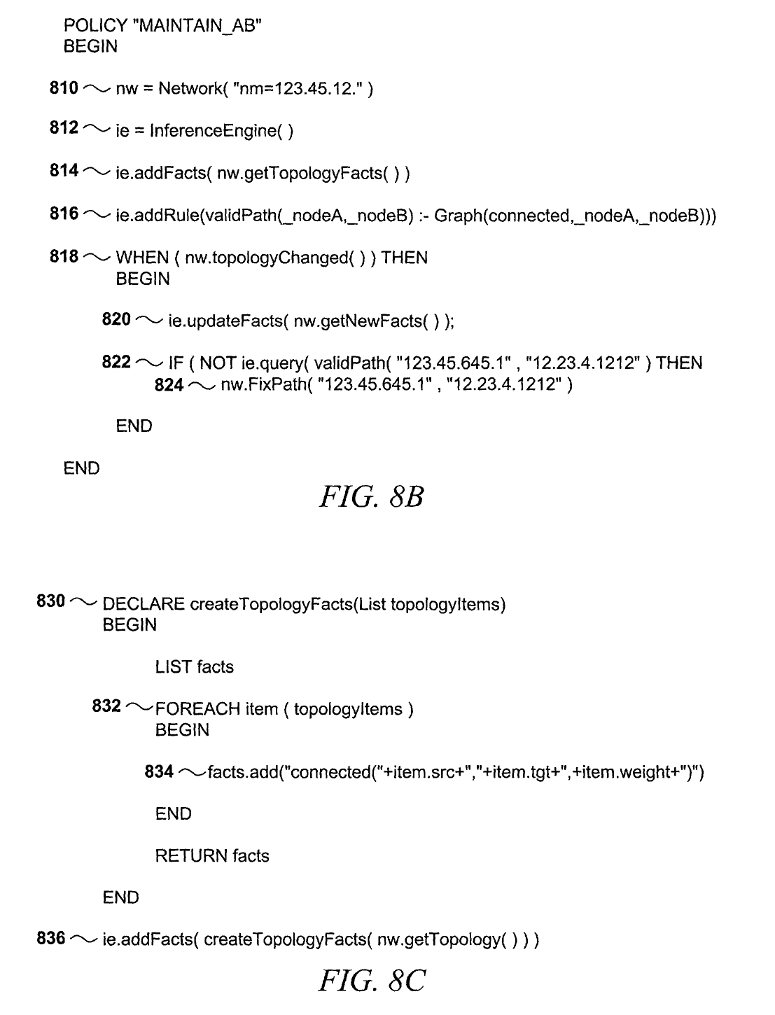

With reference now to FIGS. 8A-8C, a set of diagrams shows examples of EML statements for integrating pre-existing applications with an enterprise model in accordance with the present invention. As mentioned previously, a typical network management solution requires the use of multiple network management applications in tandem, each of which performs a set of tasks for monitoring and managing the hardware and software distributed throughout an enterprise. The present invention may be integrated with these types of applications by packaging useful functionality within an application as an object. For example, a software distribution application may be used to install and configure software applications, and a network inventory application may be used to generate a list of existing hardware and software items.

A network inventory application initially populates a database with information about all hardware and software items in an enterprise, which is followed by periodic updates to maintain an accurate inventory. Preferably, the inventory data in the database is structured in accordance with a schema that matches the enterprise model such that the information retrieval is convenient and efficient.

Referring to FIG. 8A, statement 802 shows an API of an “SD” class object from a software distribution application. In a generic manner, the statement attempts to distribute some type of deployable items to a set of deploy targets using a set of intermediate nodes during the deployment; a handle to the deployed items is returned to allow use of the items in a policy associated with the enterprise model. Deployable items are any items that can be deployed to a set of machines, e.g., software objects; intermediate nodes are nodes that are to be used as staging points for scalable deployment.

Statement 804 is a more concrete example. As a first step, the “get” method of an “INV” class object from a network inventory application is used to obtain the set of deployable items with the requested characteristics and to obtain the set of deploy targets. In this case, the “Deploy” method of the software distribution object is used to deploy a set of Windows NT™ adapter objects to all machines that have a Windows NT™ operating system. Nodes “kenya”, “chair”, and “brutus” are used as staging points by the software distribution function. As a result, a handle to all of the adapter object is returned for use by a policy associated with the enterprise model.

Referring to FIG. 8B, a set of EML statements provides an example of a policy for maintaining a connection between two nodes. At statement 810, a network object is created for a particular subnet. At statement 812, an inference engine object is created; the inference engine object is a class interface to an underlying, pre-existing application package for an inference engine written in the Prolog language. In this example, it is assumed that the developer of the network object has designed the network class to support inference technology, e.g., to support the assertion of facts and the evaluation of rules. For instance, the “nw” object, which is an object of the “Network” class, has a “getTopologyFacts( )” method that returns knowledge about the topology of the network in the form of Prolog facts, which is used at statement 814. Assuming the “Network” class already had a “getTopology( )” method that returned a topological map of a particular network, the “getTopologyFacts( )” method would be similar to the “getTopology( )” method except that the “getTopologyFacts( )” method would output Prolog facts. Hence, at statement 814, the “getTopologyFacts( )” method is used to add the pre-existing topology to the inference engine's fact database, thereby setting a basis for later comparisons to determine if there have been any changes to the network topology.

Statement 816 adds a rule to the inference engine; the Prolog rule defines valid path criteria between nodes “A” and “B” using a Prolog “Graph” package. Statement 818 defines a condition to monitor the network for changes in its topology. If the topology of the network changes, e.g., a node failure, then the inference facts are updated at statement 820. At statement 822, a query is made to determine whether there is a valid path between two nodes. If the path is invalid, then a call is made to fix the path at statement 824.

If the network class developer did not provide a method to create topology facts for use with a Prolog inference engine, then a method could be created within the EML to complete the integration. Referring to FIG. 8C, a function is declared at statement 830. Statement 832 controls a loop through the topology items to create a list of facts at statement 834, which is then returned. Statement 836 is an example of a statement that could be used in place of statement 814 to assert the topology facts for use by the inference engine.

The advantages of the present invention should be apparent in view of the detailed description of the invention that is provided above. The present invention provides an alternative approach for managing an enterprise which addresses inadequacies in current approaches, such as duplicate functionality between multiple applications and discordant usage paradigms among applications in addition to inter-product integration, installation, and configuration complexities.

The present invention is an object-based approach to enterprise management that has four phases. First, the items of interest to the enterprise are identified, which are then modeled and/or related using the EML language. EML policies are written to specify the desired monitoring and management tasks. Finally, these policies are executed.

These steps instill a level of robustness into the analysis, development, and deployment of interconnected hardware and software throughout an enterprise. Although an enterprise may use the present invention for its own systems, it may be assumed that a service provider could use the present invention under contract with an enterprise, and the service provider receives benefits at each lifecycle phase of the contract by using the present invention. In a preliminary phase, different customers can be viewed as being similar from a management perspective with respect to a fundamental enterprise model. A given customer's customized enterprise model will diverge somewhat from the fundamental model, and the present invention gives the service provider a means for measuring the amount of effort to implement a given customer's enterprise model. In a post-sales phase, specialized classes can be generated for a particular customer as necessary to integrate the customer's enterprise in accordance with the present invention. After the enterprise model has been installed and is operational, the contract may enter a maintenance phase, and the service provider can track changes to the enterprise model and sell upgrades to the enterprise model. Rather than performing its services and integrating systems in an ad hoc manner, the present invention gives a service provider a means with which to organize and account for its activities.

The EML language provides a common bond between all aspects of the enterprise; EML is used to define all the items of interest, the enterprise model suitable for the needs of the enterprise, and the desired policies. Since a single language is used, a seamless view of the enterprise is presented. Furthermore, because the model is tailored to the enterprise's needs, and because EML uses concepts with which IT personnel are familiar, a minimal learning curve is required to understand and use the model. The semantics of the language have implicit configuration and deployment mechanisms which reduce the effort required by the user. The policies to be executed in a flexible fashion; they can be prioritized, run in parallel, and/or distributed to desired nodes for execution, thereby providing a scalable solution.

The present invention also allows an enterprise to leverage its current investment in previously installed products and is compatibility with various technologies, which would be capsulated as objects and used in policies as necessary. Moreover, the present invention can unify applications not only at a user interface level but also at the underlying architectural level.

It is important to note that while the present invention has been described in the context of a fully functioning data processing system, those of ordinary skill in the art will appreciate that some of the processes associated with the present invention are capable of being distributed in the form of instructions in a computer readable medium and a variety of other forms, regardless of the particular type of signal bearing media actually used to carry out the distribution. Examples of computer readable media include media such as EPROM, ROM, tape, paper, floppy disc, hard disk drive, RAM, and CD-ROMs and transmission-type media, such as digital and analog communications links.

The description of the present invention has been presented for purposes of illustration but is not intended to be exhaustive or limited to the disclosed embodiments. Many modifications and variations will be apparent to those of ordinary skill in the art. The embodiments were chosen to explain the principles of the invention and its practical applications and to enable others of ordinary skill in the art to understand the invention in order to implement various embodiments with various modifications as might be suited to other contemplated uses.

What is claimed is:

1. A method for monitoring or managing a network using an object-oriented enterprise model, the method comprising:
generating a set of objects, wherein an object represents a device, a system, a collection of devices and/or systems, an executable program component, or a collection of executable program components within the network, and wherein an object is defined using an object-oriented language;
defining an enterprise model using the object-oriented language, wherein the enterprise model is a set of related objects; and
creating a policy using the object-oriented language, wherein a policy comprises a condition and an associated action within the network.

2. The method of claim 1 further comprising:
executing the policy to perform a monitoring and/or management task within the network.

3. The method of claim 1 further comprising:
defining a condition with an operator having an object as an operand, and wherein an operator is defined within the object-oriented language.

4. The method of claim 1 further comprising:
defining an action with an operation on an object within the enterprise model, wherein the operation is defined within an object-oriented class for the object.

5. A method for monitoring or managing a network using an object-oriented enterprise model, the method comprising:
retrieving a policy, wherein the policy comprises a set of object-oriented language statements describing a condition and an associated action within the network;
accessing an enterprise model, wherein the enterprise model is a set of related objects, wherein an object represents a device, a system, a collection of devices and/or systems, an executable program component, or a collection of executable program components within the network, and wherein an object is defined using an object-oriented language; and
interpreting the policy to perform a monitoring and/or management task within the network.

6. The method of claim 5 further comprising:
defining a condition with an operator having an object as an operand, and wherein an operator is defined within the object-oriented language.

7. The method of claim 5 further comprising:
defining an action with an operation on an object within the enterprise model, wherein the operation is defined within an object-oriented class for the object.

8. An apparatus for monitoring or managing a network using an object-oriented enterprise model, the apparatus comprising:
generating means for generating a set of objects, wherein an object represents a device, a system, a collection of devices and/or systems, an executable program component, or a collection of executable program components within the network, and wherein an object is defined using an object-oriented language;
first defining means for defining an enterprise model using the object-oriented language, wherein the enterprise model is a set of related objects; and
creating means for creating a policy using the object-oriented language, wherein a policy comprises a condition and an associated action within the network.

9. The apparatus of claim 8 further comprising:
executing means for executing the policy to perform a monitoring and/or management task within the network.

10. The apparatus of claim 8 further comprising:
second defining means for defining a condition with an operator having an object as an operand, and wherein an operator is defined within the object-oriented language.

11. The apparatus of claim 8 further comprising:
third defining means for defining an action with an operation on an object within the enterprise model, wherein the operation is defined within an object-oriented class for the object.

12. An apparatus for monitoring or managing a network using an object-oriented enterprise model, the apparatus comprising:
retrieving means for retrieving a policy, wherein the policy comprises a set of object-oriented language statements describing a condition and an associated action within the network;
accessing means for accessing an enterprise model, wherein the enterprise model is a set of related objects, wherein an object represents a device, a system, a collection of devices and/or systems, an executable program component, or a collection of executable program components within the network, and wherein an object is defined using an object-oriented language; and
interpreting means for interpreting the policy to perform a monitoring and/or management task within the network.

13. The apparatus of claim 12 further comprising:
first defining means for defining a condition with an operator having an object as an operand, and wherein an operator is defined within the object-oriented language.

14. The apparatus of claim 12 further comprising:
second defining means for defining an action with an operation on an object within the enterprise model, wherein the operation is defined within an object-oriented class for the object.

15. A computer program product on a computer readable medium for use in a data processing system for monitoring or managing a network using an object-oriented enterprise model, the computer program product comprising:
instructions for generating a set of objects, wherein an object represents a device, a system, a collection of devices and/or systems, an executable program component, or a collection of executable program components within the network, and wherein an object is defined using an object-oriented language;
instructions for defining an enterprise model using the object-oriented language, wherein the enterprise model is a set of related objects; and
instructions for creating a policy using the object-oriented language, wherein a policy comprises a condition and an associated action within the network.

16. The computer program product of claim 15 further comprising:
instructions for executing the policy to perform a monitoring and/or management task within the network.

17. The computer program product of claim 15 further comprising:
instructions for defining a condition with an operator having an object as an operand, and wherein an operator is defined within the object-oriented language.

18. The computer program product of claim 15 further comprising:
instructions for defining an action with an operation on an object within the enterprise model, wherein the operation is defined within an object-oriented class for the object.

19. A computer program product on a computer readable medium for use in a data processing system for monitoring or managing a network using an object-oriented enterprise model, the computer program product comprising:
instructions for retrieving a policy, wherein the policy comprises a set of object-oriented language statements describing a condition and an associated action within the network;
instructions for accessing an enterprise model, wherein the enterprise model is a set of related objects, wherein an object represents a device, a system, a collection of devices and/or systems, an executable program component, or a collection of executable program components within the network, and wherein an object is defined using an object-oriented language; and
instructions for interpreting the policy to perform a monitoring and/or management task within the network.

20. The computer program product of claim 19 further comprising:
instructions for defining a condition with an operator having an object as an operand, and wherein an operator is defined within the object-oriented language.

21. The computer program product of claim 19 further comprising:
instructions for defining an action with an operation on an object within the enterprise model, wherein the operation is defined within an object-oriented class for the object.
